(19) United States
(12) Patent Application Publication
(10) Pub. No.: US 2009/0114580 A1
(43) Pub. Date: May 7, 2009

(54) ONE PIECE TAPPING PLATE FOR HEAVY DUTY FILTERS

(76) Inventor: Zafar Hussain, Perrysburg, OH (US)

Correspondence Address: HONEYWELL INTERNATIONAL INC., 101 COLUMBIA ROAD, P O BOX 2245, MORRISTOWN, NJ, 07962-2245, US

(21) Appl. No.: 12/261,265

(22) Filed: Oct. 30, 2008

Related U.S. Application Data
(60) Provisional application No. 60/984,499, filed on Nov. 1, 2007.

(51) Int. Cl. B01D 27/08; B01D 35/02

(52) U.S. Cl. 210/167.02; 210/440

(57) ABSTRACT

A one-piece tapping plate for a filter assembly, the tapping plate being configured to secure the filter assembly to a filter mount of an oil circulation system is provided. The tapping plate comprising: a unitary structure having a plurality of openings for providing a plurality of fluid pathways for a fluid to flow through, a threaded portion located proximate to an upper end of the one-piece tapping plate, the threaded portion being configured for correspondingly engaging with a threaded wall portion of the filter mount securing the filter assembly to the filter mount; and a central aperture for engaging with the filter mount and providing a fluid outlet port for filtered fluid to flow therethrough, the plurality of openings being located between the threaded portion and the central aperture.

### CROSS REFERENCE TO RELATED APPLICATIONS

The present application claims the benefit of U.S. Provisional application, Ser. No. 60/984,499, filed Nov. 1, 2007, the contents of which are incorporated herein by reference thereto.

### BACKGROUND

In modern automobiles, many types of fluid filters are common. Fluid filters (e.g. oil filters) are commonly used in engine lubrication systems, hydraulic systems, and fuel systems to remove abrasive particles from the fluid being circulated. Most filters use a mechanical or ‘screening’ type of filtration, with a replaceable cartridge having a porous filter element therein, through which oil is repeatedly cycled to remove abrasive impurities such as small particles or dirt. “Dirty” fluid enters an oil filter under pressure, passes through the filter media where it is “cleaned,” and then is redistributed throughout the engine. This can prevent premature wear by ensuring that impurities will not circulate through the engine and reach the close fitting engine parts. Filtering also increases the usable life of the oil.

Most oil filter assemblies include a filtration mechanism (e.g. filter) and a tapping plate for mounting or installing the filter onto a filter mount extending from an engine. These filter assemblies also include a separate ring piece having a plurality of apertures formed horizontally along a planar surface of the ring piece for providing fluid passages for oil to flow through for filtering. Both the tapping plate and ring piece are generally positioned atop an end disc secured to one end of a filtering element disposed within a housing of a filter assembly. The tapping plate and ring piece are disposed within the housing such that the ring piece engages with the end disc and the tapping plate is placed directly on top of the ring piece, wherein an interference fit is provided. Typically, an O-Ring is placed between the ring piece and end disc to seal the spud of the filter mount and filter outlet. In this case, the end disc is formed with a special cavity or seat for receiving the O-Ring. Alternatively, a grommet is used to seal the end disc and engine head spud.

Accordingly, it is desirable to provide a one-piece tapping plate designed to function as a tapping plate as well as a spacer between the tapping plate and an end disc of an oil filtration device (e.g. filter) to create a passage for oil flow with minimum restriction and a filter assembly incorporating the same. It is also desirable to provide a method of assembling a filter assembly having a one-piece tapping plate using a J-Seam or rolling process.

### SUMMARY

In one exemplary embodiment, a one-piece tapping plate for a filter assembly is provided, the tapping plate being configured to secure the filter assembly to a filter mount of an oil circulation system. The tapping plate comprising: a unitary structure having a plurality of openings for providing a plurality of fluid pathways for a fluid to flow through, a threaded portion located proximate to an upper end of the one-piece tapping plate, the threaded portion being configured for correspondingly engaging with a threaded wall portion of the filter mount securing the filter assembly to the filter mount; and a central aperture for engaging with the filter mount and providing a fluid outlet port for filtered fluid to flow therethrough, the plurality of openings being located between the threaded portion and the central aperture.

In another exemplary embodiment, a filter assembly for an oil circulation system having a filter mount extending therefrom is provided. The filter assembly comprising: a housing; a filter element disposed within the housing, the filter element being configured for filtering a fluid, the filter element having a first end disc and a second end disc, the first end disc being proximate to a first side of the filter element; a one-piece tapping plate having a plurality of openings for providing a plurality of fluid pathways for the fluid to flow through the one-piece tapping plate having a threaded portion located proximate to an upper end of the one-piece tapping plate, the threaded portion being configured for correspondingly engaging with a threaded wall portion of the filter mount securing the filter assembly to the filter mount, and a central aperture for engaging with the filter mount and providing a fluid outlet port for filtered fluid to flow therethrough, the plurality of openings being located between the threaded portion and the central aperture; and a grommet disposed between the one-piece tapping plate and the first end disc, the grommet providing a seal between the filter mount and the first end disc.

In another exemplary embodiment, a method for assembling a filter assembly configured to be secured to a filter mount of an oil circulation system is provided. The method comprising: disposing a filter element being configured for filtering a fluid within a housing, the filter element having a first end disc and a second end disc, the first end disc is secured to a top portion of the filter element; and installing a one-piece tapping plate having a plurality of openings for providing a plurality of fluid pathways for the fluid within the housing, the one-piece tapping plate includes a threaded portion located proximate to an upper end of the one-piece tapping plate, the threaded portion being configured for correspondingly engaging with a threaded wall portion of the filter mount, and a central aperture for engaging with the filter mount and providing a fluid outlet port for filtered fluid to flow therethrough, the plurality of openings being located between the threaded portion and the central aperture.

### BRIEF DESCRIPTION OF DRAWINGS:

FIG. 1 illustrates a cross-sectional view of a filter assembly in accordance with an exemplary embodiment of the present invention;

FIG. 2 illustrates an exploded cross-sectional view of an upper portion of the filter assembly in accordance with an exemplary embodiment of the present invention;

FIG. 3 illustrates a top perspective view of a one-piece tapping plate in accordance with an exemplary embodiment of the present invention; and

FIG. 4 illustrates a bottom perspective view of a one-piece tapping plate in accordance with an exemplary embodiment of the present invention.

### DESCRIPTION OF EXEMPLARY EMBODIMENTS

Exemplary embodiments of the present invention are directed to a one-piece tapping plate designed to function as a tapping plate as well as a spacer between the tapping plate and an end disc of an oil filtration device (e.g. filter) to create a passage for oil flow with minimum restriction. Exemplary embodiments of the present invention are also directed to a filter assembly incorporating a one-piece tapping plate that can be used to both install a filter onto a filter mount extending from an engine and allow oil to flow through the tapping plate without causing restriction.

Exemplary embodiments of the present invention are also directed to a filter assembly with the aforementioned one-piece tapping plate while the same is secured to the filter housing by a J-Seam or rolling process or equivalent securing process.

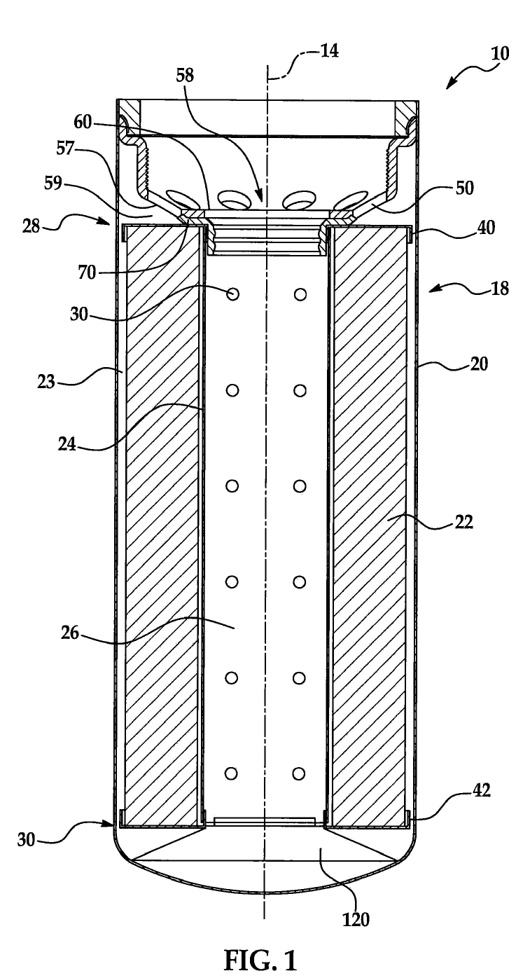

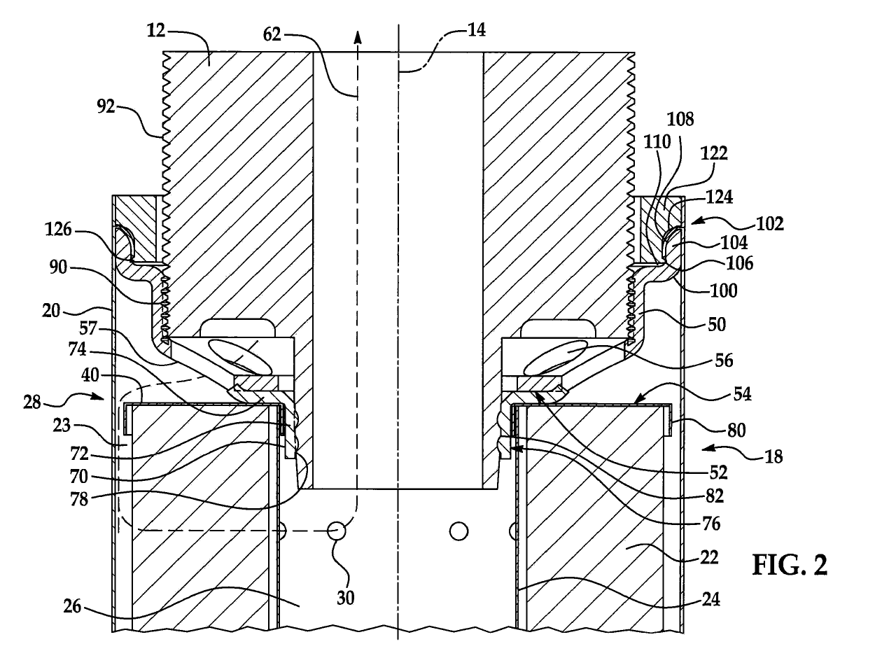

Referring now to FIGS. 1 and 2, a filtering device or assembly 10 is shown according to an exemplary embodiment of the present invention. The filter assembly 10 is configured to be mounted onto a filter mount 12 of an engine (not shown). Specifically, filter assembly 10 is adapted to be operably mounted to and in communication with a lubrication system, hydraulic system, fuel system, or other fluid circulation-type systems that benefit from fluid filtration provided by the assembly. Filter assembly 10 has an axial center 14 in which the filter components are reflected on both sides of the axial center.

In one exemplary embodiment, filter assembly 10 includes a filtration mechanism or filter 18 having a housing, frame, or can 20 surrounding a filtering element or member 22, which is configured to remove materials, such as dirt and abrasives, from a fluid (e.g., oil) being circulated, in accordance with one exemplary embodiment of the present invention.

In one exemplary embodiment, the filtering element 22 is disposed within and supported by the housing 20 as shown. A primary fluid channel 23 is defined between housing 20 and filtering element 22 in which “dirty” fluid from the engine flows through in order to get filtered from filtering element 22. In one non-limiting exemplary embodiment, filtering element 22 has a cylindrical cross-sectional shape and includes an inner periphery and an outer periphery. Of course, other cross-sectional shapes are contemplated, such as oval, rectangular, oblong, etc.

In one exemplary embodiment, the filter assembly 10 includes a cylindrical core or sleeve, or center fuse 24 that is axially positioned within the inner periphery of the filtering element 22 and about axial center 14, thereby forming a hollow axial region in which a secondary fluid channel 26 is defined for “clean” or filtered fluid to flow therethrough. In this exemplary embodiment, cylindrical core 24 includes a plurality of apertures 30 for filtered fluid to flow through and into secondary fluid channel 26. The number, diameter size, and configuration of apertures 30 formed along the walls of cylindrical core 24 vary depending on the needed filtering capacity and application and should not be limited to the exemplary number, size, and configuration of apertures 30 shown in FIGS. 1 and 2.

The secondary fluid channel 26 extends proximate to a top portion 28 and a bottom portion 30 portion of filtering element 22. The cylindrical core 24 may be of any conventional design and may be made of any material having sufficient strength and which is compatible with the fluid being filtered. The cylindrical core 24 provides support to the inner periphery of the filtering element 22 against forces in the radial direction and also helps to give filtering element 22 axial strength and rigidity against bending forces or the like.

In one exemplary embodiment, a first end disc 40 and a second end disc 42 are secured to the top portion 28 and bottom portion 30 of filtering element 22 respectively. In one non-limiting exemplary embodiment, the end discs are secured to the filtering element 22 by any means for securing such as, for example, a weld, a braze, a gasket, or any other known means. Other conventional techniques, such as by use of an epoxy, thermal bonding, or spin welding can be used to attach end disks 40, 42 to portions 28, 30 of filtering element 22 respectively.

In accordance with an exemplary embodiment of the present invention, the filter assembly 10 includes a tapping plate 50. Advantageously, the tapping plate 50 is a one-piece design that functions both as a means for installing or mounting the filter assembly onto the filter mount 12 extending from the engine as well as provides a spacer between the tapping plate 50 and the first end disc 40. The one-piece tapping plate is configured to create a passage for fluid flow with minimum restriction, which will be become more apparent with the description below.

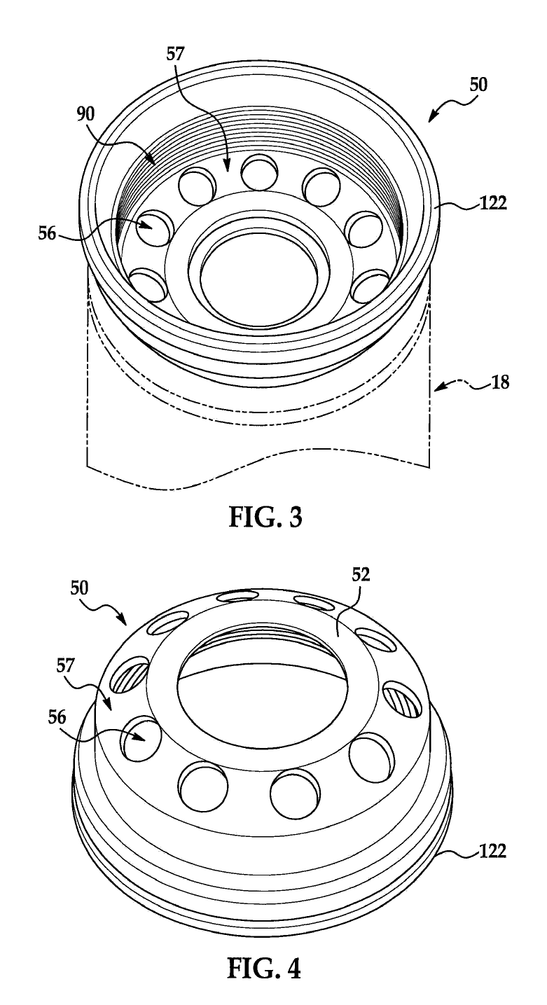

In one non-limiting exemplary embodiment, the tapping plate 50 generally has a concave circular cross-sectional shape and in one exemplary embodiment is constructed out of a metal material, such as steel, iron or the like. The tapping plate 50 is disposed within and secured to housing 18 such that a bottom surface portion 52 of the tapping plate 50 lies generally parallel to a planar surface 54 of first end disc 40. In one exemplary embodiment, tapping plate 50 includes a plurality of openings or fluid inlet ports 56. The tapping plate 50 defines a central aperture 58 about axial center 14. The openings 56 are spaced apart and positioned generally around and adjacent to central aperture 58 as shown. The openings 56 provide fluid pathways for “dirty” fluid to flow through and into the primary fluid channel 23 and consequently through filtering element 22 for filtration. In one non-limiting exemplary embodiment, openings 56 are formed along a transverse wall portion 57 of tapping plate 50 as shown in FIGS. 2-4. As such, openings 56 generally lie transverse with respect to the planar surface 54 of first end disc 40, thereby forming a space or gap 59 between the first end disc 40 and the plurality of openings 56 for fluid to flow through with minimum restriction. It should be understood that the number, diameter size, and configuration of openings 56 formed along wall portion 57 of tapping plate 50 could vary depending on the needed filtering capacity and application and should not be limited to the exemplary number, size, and configuration of openings 56 shown in FIGS. 1-4.

In one exemplary embodiment, the tapping plate 50 defines a fluid outlet port 60. The fluid outlet port 60 is in fluid communication with secondary fluid channel 26. Thus, fluid outlet port 60 allows filtered fluid from filtering element 22 to flow through fluid outlet port 60 and back to the engine. As a result, a fluid path, which is indicated by arrow 62 in FIG. 2, extends from fluid inlet ports 56 and primary fluid channel 23 through filtering element 22 and apertures 30 of axial core 24 to fluid outlet port 60.

In one exemplary embodiment, a grommet 70 having a shaft portion 72 and a disk portion 74 is a seal between tapping plate 50 and first end disc 40. Grommet 70 seals the spud of filter mount 12 and fluid outlet port 60. In one exemplary embodiment, shaft portion 72 of grommet 70 is disposed within the inner periphery of filtering element 22 and disk portion 74 engages with first end disk 40 when the shaft portion 72 is fully inserted within the inner periphery of filtering element 22. More specifically, portions of an outer diameter surface 76 of shaft portion 72 engage with an outer diameter portion 80 of first end disc 40 while an inner diameter surface 78 having threads of shaft portion 72 correspondingly engage with a wall portion 82 of filter mount 12 as shown.

As illustrated, grommet 70 includes a cavity at the disk portion 74 of the grommet 70 for receiving tapping plate 50. In an alternative exemplary embodiment, tapping plate 50 is placed atop a periphery surface of the disk portion 74 such that bottom surface portion 52 of tapping plate 50 engages a periphery surface of disk portion 74. As such, when the shaft portion 72 of grommet 70 is inserted within the inner periphery of filtering element 22 and tapping plate 50 is placed atop grommet 70 or received by the cavity of grommet 70 a seal is formed between tapping plate 50 and first end disc 40. The above arrangement prevents “dirty” fluid to flow through the secondary fluid channel 26. Instead, “dirty” fluid is forced or routed to the primary fluid channel 23 for filtering. The filtered fluid then flows through filtering element 22 and apertures 30 of axial core 24 into secondary fluid channel 26 and out fluid output port 60 as described above.

Tapping plate 50 includes a threaded portion 90 for correspondingly engaging or mating with a threaded wall portion 92 of filter mount 12. In one non-limiting exemplary embodiment threaded portion 90 has M59 (metric size) internal threads. Of course, varying size threads may be formed on threaded portion 80 of tapping plate 50. The threaded portion 90 of tapping plate 50 secures the filtering assembly 10 to the filter mount 12. In other words, the threaded portion 90 of tapping plate 50 is used to mount the tapping plate 50 of filter assembly 10 onto the filter head of the filter mount 12 extending from the engine by spinning tapping plate 50 onto the filter mount 12 such that threaded portion 90 of tapping plate 90 engages with threaded wall portion 92 of filter mount 12 as shown.

As illustrated, tapping plate 50 defines a tapping edge 100 extending around the periphery of tapping plate 50 proximate to an upper end 102 of tapping plate 50. Tapping edge 100 generally has an L-shaped profile. In one exemplary embodiment, an extension member 104 is formed integrally with tapping plate 50 to form an upward protrusion extending from tapping edge 100 to upper end 102 of the tapping plate 50 as shown. The inner periphery surface of tapping edge 100 defines a shoulder 106. A contacting feature 108 is located at one end of housing 20 and is bent over and substantially around the periphery of extension member 104 of tapping plate 50 in order to secure the same to the housing 20. The contacting feature 108 of housing 20 is bent over extension member 104 of tapping plate 50 such that a crevice 110 is formed between the housing 20 and tapping plate 50 proximate shoulder 106, thus sending all axial loads through housing 20. The bending of contacting feature 108 of housing 20 over extension member 104 of tapping plate 50 provides for an interference fit between tapping plate 50 and grommet 70. Such process also allows for an interference fit between grommet 70 and end disc 40. The process of bending contacting feature 108 of housing 20 over extension member 104 of tapping plate 50 can be referred to as a J-Seam process or rolling process.

In one exemplary embodiment, a retainer 120 having a spring mechanism (not shown) is located adjacent the bottom portion 30 of filtering element 22 and within housing 20. The retainer 120 secures the filtering element 22 within housing 20. In one exemplary embodiment, retainer 120 is secured to the housing by any means for securing, such as, for example, a ceramic paste, a weld, a braze, gasket, or any other known means. In one exemplary embodiment, retainer 120 is provided for biasing the filtering element 22 upward relative to FIG. 1. In one exemplary embodiment, second end disc 40 is pressed against retainer 120, wherein an interference fit is provided. In an alternative exemplary embodiment, retainer 120 is secured to second end disc 42 by any means for securing such as, for example, ceramic paste, a weld, a braze, a gasket, or any other known means.

In one exemplary embodiment, a gasket 122 having an edge 124 with a notch portion 126, in accordance with one exemplary embodiment, is disposed above tapping plate 50. In one exemplary embodiment, the gasket 122 can be used to provide a seal between the filter assembly and the filter mount. In one non-limiting exemplary embodiment, the edge 124 generally has a concave profile as shown. The gasket 122 is disposed above tapping plate 50 such that edge 124 of gasket 122 engages contacting feature 108 of housing 20 that is bent over extension member 104 of tapping plate 50 while notch portion 126 of gasket 122 is received by crevice 110 defined between housing 20 and tapping plate 50. With this arrangement, the gasket 122 is secured between housing 20 and tapping plate 50.

In accordance with an exemplary embodiment of the present invention an exemplary method of assembling filter assembly 10 is provided that uses a J-seam or rolling process in one exemplary embodiment of the present invention. The exemplary method generally includes disposing filtering element 22 having first end disc 40 and second end disc 42 secured to top portion 28 and bottom portion 30 of filtering element respectively within housing 20 such that second end disc 42 presses against retainer 120, which is secured to housing 20. Optionally, second end disc 42 can be secured to retainer 120 by any known means for securing, such as a weld. Then, inserting shaft portion of grommet 70 within the inner periphery of filtering element, thus having disk portion 74 of grommet 70 engage with portions of the planar surface 54 of first end disc 40 as illustrated in FIG. 2, wherein an interference fit is provided. Next and in accordance with an exemplary embodiment of the present invention the tapping plate 50 is disposed atop grommet 70 or received by the cavity of grommet 70 as illustrated in FIG. 2, wherein an interference fit is provided.

The method also includes bending contacting feature 108 of housing 20 over extension member 104 of tapping plate 50, thus sending all axial loads through housing 20. Then, disposing gasket 122 above tapping plate 50 such that edge 124 of gasket 122 engages contacting feature 108 of housing 20 that is bent over extension member 104 of tapping plate 50 while notch portion 126 of gasket 122 is received by crevice 110 defined between housing 20 and tapping plate 50 as shown, thus securing gasket 122 between housing 20 and tapping plate 50 proximate shoulder 106. Next, spinning tapping plate 50 onto filter mount 12 extending from the engine or hydraulic system such that wall portion 82 engages with the threads of inner diameter surface 78 of shaft portion 72 and threaded portion 90 of tapping plate 50 correspondingly mates with threaded wall portion of filter mount 12.

In one exemplary embodiment, filter 18 is a heavy-duty oil filter. Of course, other various types of filters can be used in conjunction with the exemplary embodiments of tapping plate 50 that is designed to function as a tapping plate as well as a spacer between the tapping plate and the end disc to create a passage for oil flow with minimum restriction.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims and their legal equivalence.

What is claimed is:

1. A one-piece tapping plate for a filter assembly, the tapping plate being configured to secure the filter assembly to a filter mount of an oil circulation system, the tapping plate comprising:
a unitary structure having a plurality of openings for providing a plurality of fluid pathways for a fluid to flow through;
a threaded portion located proximate to an upper end of the one-piece tapping plate, the threaded portion being configured for correspondingly engaging with a threaded wall portion of the filter mount securing the filter assembly to the filter mount; and
a central aperture for engaging with the filter mount and providing a fluid outlet port for filtered fluid to flow therethrough, the plurality of openings being located between the threaded portion and the central aperture.

2. The one-piece tapping plate as in claim 1, wherein the plurality of openings are formed along a transverse wall portion of the one-piece tapping plate.

3. The one-piece tapping plate as in claim 1, wherein the plurality of openings generally lie transverse with respect to a planar surface of a first end disc engaged with a filtering element of the filter assembly forming a gap between the first end disc and the plurality of openings for the fluid to flow through.

4. The one-piece tapping plate as in claim 1, wherein the one-piece tapping plate has an extension member formed integrally with the one-piece tapping plate, the extension member forms an upward protrusion extending from a tapping edge defined at one end of the tapping plate, the extension member being configured to secure the one-piece tapping plate to a housing of the filter.

5. A filter assembly for an oil circulation system having a filter mount extending therefrom, the filter assembly comprising:
a housing;
a filter element disposed within the housing, the filter element being configured for filtering a fluid, the filter element having a first end disc and a second end disc, the first end disc being proximate to a first side of the filter element;
a one-piece tapping plate having a plurality of openings for providing a plurality of fluid pathways for the fluid to flow through the one-piece tapping plate having a threaded portion located proximate to an upper end of the one-piece tapping plate, the threaded portion being configured for correspondingly engaging with a threaded wall portion of the filter mount securing the filter assembly to the filter mount, and a central aperture for engaging with the filter mount and providing a fluid outlet port for filtered fluid to flow therethrough, the plurality of openings being located between the threaded portion and the central aperture; and
a grommet disposed between the one-piece tapping plate and the first end disc, the grommet providing a seal between the filter mount and the first end disc.

6. The filter assembly as in claim 5, wherein the plurality of openings are formed along a transverse wall portion of the one-piece tapping plate.

7. The filter assembly as in claim 5, wherein the plurality of openings generally lie transverse with respect to a planar surface of the first end disc forming a gap between the first end disc and the plurality of openings for the fluid to flow through.

8. The filter assembly as in claim 5, further comprising a gasket configured to be disposed within a shoulder formed between the threaded portion and an upper end of the one-piece tapping plate providing a seal between the filter assembly and the filter mount.

9. The filter assembly as in claim 8, wherein an edge of the gasket engages with the housing and a notch portion of the gasket is received by a crevice defined between the housing and the one-piece tapping plate.

10. The filter assembly as in claim 5, wherein the one-piece tapping plate has an extension member formed integrally with the one-piece tapping plate, the extension member forms an upward protrusion extending from a tapping edge defined at one end of the one-piece tapping plate, the extension member being configured to secure the one-piece tapping plate to the housing.

11. The filter assembly as in claim 10, wherein a contacting feature of the housing is bent over the extension member of the one-piece tapping plate when the tapping plate is disposed within the housing securing the one-piece tapping plate to the housing.

12. The filter assembly as in claim 11, further comprising a gasket configured to be disposed within a shoulder formed between the threaded portion and an upper end of the one-piece tapping plate providing a seal between the filter assembly and the filter mount.

13. The filter assembly as in claim 12, wherein an edge of the gasket engages with the contacting feature of the housing and a notch portion of the gasket is received by a crevice defined between the contacting feature of the housing and the tapping plate.

14. A method for assembling a filter assembly 10 configured to be secured to a filter mount of an oil circulation system, the method comprising:
disposing a filter element being configured for filtering a fluid within a housing, the filter element having a first end disc and a second end disc, the first end disc is secured to a top portion of the filter element; and
installing a one-piece tapping plate having a plurality of openings for providing a plurality of fluid pathways for the fluid within the housing, the one-piece tapping plate includes a threaded portion located proximate to an upper end of the one-piece tapping plate, the threaded portion being configured for correspondingly engaging with a threaded wall portion of the filter mount, and a central aperture for engaging with the filter mount and providing a fluid outlet port for filtered fluid to flow therethrough, the plurality of openings being located between the threaded portion and the central aperture.

15. The method of claim 14, wherein a grommet is disposed between the one-piece tapping plate and the first end disc, the grommet being configured for providing a seal between the filter mount and first end disc.

16. The method of claim 14, wherein a contacting feature of the housing is bent over an extension member of the one-piece tapping plate when the one-piece tapping plate is disposed within the housing securing the one-piece tapping plate to the housing.

17. The method of claim 16, wherein the extension member is formed integrally with the one-piece tapping plate, the extension member forms an upward protrusion extending from a tapping edge defined at one end of the one-piece tapping plate, the extension member being configured to secure the one-piece tapping plate to the housing.

18. The method of claim 14, wherein the plurality of openings are formed along a transverse wall portion of the one-piece tapping plate.

19. The method of claim 14, wherein the plurality of openings generally lie transverse with respect to a planar surface of the first end disc forming a gap between the first end disc and the plurality of openings for the fluid to flow through the one-piece tapping plate.
